(19) United States
(12) Patent Application Publication
(10) Pub. No.: US 2015/0101250 A1
(43) Pub. Date: Apr. 16, 2015

(54) VARIABLE-WIDTH SECURITY GATE UNIT

(71) Applicant: Cosco Management, Inc., Wilmington, DE (US)

(72) Inventor: Andrew W. Marsden, Hingham, MA (US)

(21) Appl. No.: 14/510,721

(22) Filed: Oct. 9, 2014

Related U.S. Application Data
(60) Provisional application No. 61/889,098, filed on Oct. 10, 2013.

(51) Int. Cl. E06B 9/06; E06B 3/50; E06B 9/00; E05B 65/00; E06B 11/04

(52) U.S. Cl. CPC E06B 9/06; E05B 65/0014; E06B 11/045; E06B 9/00; E06B 3/5072; E06B 2009/002
USPC 49/55; 49/465; 49/177

(57) ABSTRACT

A gate is mounted on a frame to pivot about a pivot axis between opened and closed positions.

### PRIORITY CLAIM

This application claims priority under 35 U.S.C. §119(e) to U.S. Provisional Application Ser. No. 61/889,098, filed Oct. 10, 2013, which is expressly incorporated by reference herein.

### BACKGROUND

The present disclosure relates to movable barriers, and particularly to security gates. More particularly, the present disclosure relates to a variable-width security gate for use in a doorway inside a dwelling.

### SUMMARY

A gate unit in accordance with the present disclosure includes a gate that can be moved in a doorway about a pivot axis by a person between closed and opened positions. In the closed position, the gate is arranged to block movement through the doorway.

In illustrative embodiments, the gate unit is configured to be varied in width at the option of a caregiver. The gate unit also includes a gate mount that is adapted to mate with a door frame bordering the doorway. The gate mount is configured to support the gate for pivotable movement about the pivot axis between a closed position closing a walkway passage formed in the gate mount to block movement of a person through the walkway passage to an opened position opening the walkway position to allow movement of a person through the walkway passage. A latch is carried on the pivotable gate and arranged to engage a latch receiver provided in the gate mount to lock the gate in the closed position.

In illustrative embodiments, the gate mount is U-shaped and is configured to be varied in width at the option of a caregiver to fit both narrow and relatively wider doorways. The variable-width gate mount includes an extensible foundation bar arranged to extend along the floor in the doorway, a first side post arranged to extend upwardly from a first end of the extensible foundation bar to mate with a first vertical doorjamb included in the door frame, and a second side post arranged to extend upwardly from a second end of the extensible foundation bar to lie in spaced-apart relation to the first side post and mate with a second vertical doorjamb included in the door frame.

In illustrative embodiments, the extensible foundation bar of the U-shaped gate mount includes a first rail coupled to the first side post and a second rail coupled to the second side post and mounted to slide relative to the first rail to vary the width of the gate mount. The extensible foundation bar also includes a rail lock mounted on the first rail and configured to retain the second rail in a selected stationary position relative to the first rail at the option of a caregiver to establish and fix the width of the gate mount.

In illustrative embodiments, the gate is configured to be varied in width at the option of a caregiver to match the width of the gate mount. The gate includes a pivotable first panel supported on a hinge included in the gate mount and coupled to the first side post for swinging movement about the pivot axis. The gate also includes a slidable second panel supported for lateral sliding movement relative to the pivotable first panel to vary the width of the gate at the option of a caregiver to match the narrow or wide width of the variable-width gate mount. The extensible foundation bar included in the U-shaped gate mount is positioned to lie below and under the first and second panels of the gate.

In illustrative embodiments, the gate unit further includes a swing-direction controller coupled to the gate to pivot therewith. The swing-direction controller is operable to control the swing direction of the gate about a vertical pivot axis at the option of a caregiver. The swing-direction controller includes a flange carrier mounted in a stationary position on the slidable second panel of the gate and separate front and rear motion-blocker flanges mounted for pivotable movement on the stationary flange carrier about a horizontal pivot axis between undeployed positions aligned with the extensible foundation bar to avoid engagement with the extensible foundation bar located below and under the first and second panels of the gate during swinging movement of the gate about the vertical pivot axis and downwardly extending deployed positions arranged to intercept and engage the extensible foundation bar to block further swinging movement of the gate about the vertical pivot axis.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a front perspective view of a gate unit in accordance with the present disclosure placed in a narrow-width doorway and showing that the gate unit includes a U-shaped gate mount mating with a door frame bordering the doorway and a two-panel gate mounted on the U-shaped gate mount for swinging movement about a vertical pivot axis between a closed position (shown in solid) and an opened position (shown in phantom) and showing that the U-shaped gate mount includes an extensible foundation bar arranged to extend along the floor in the doorway below and under the gate and that the extensible foundation bar is made of two rails interconnectable for relative slidable movement and a rail lock as suggested in FIGS. 5-9;

FIG. 2 is a view similar to FIG. 1 showing the gate unit after it has been removed from the narrow-width doorway and after the rail lock in the extensible foundation bar has been operated by a caregiver as suggested in FIG. 8 to release the right-side rail so that it can be moved relative to the relatively stationary left-side rail in telescoping relation as suggested in FIG. 3 to widen the gate mount to a width that matches the width of a relatively wider doorway shown in FIG. 4;

FIG. 3 is a view similar to FIGS. 1 and 2 showing sliding movement of a right-side panel included in the gate to the right toward a right side post of the U-shaped gate mount and relative to a stationary left-side panel included in the gate and mounted on a hinge coupled to the left side post of the U-shaped gate mount for pivotable movement about a vertical pivot axis as suggested in FIG. 1;

FIG. 4 is a view similar to FIGS. 1-3 after widening of both of the gate mount and the multi-panel gate to provide the gate unit with a width matching the width of the relatively wider doorway and showing that the relatively wider gate unit has been placed in the relatively wider doorway while the gate is maintained in the closed position;

FIG. 5 is an exploded perspective assembly view of the gate unit of FIGS. 1-4 showing that the gate mount is U-shaped and includes an extensible foundation bar comprising a left-side rail, a rail lock, and a right-side rail adapted to slide relative to the left-side rail when the rail lock is unlocked to vary the width of the U-shaped gate mount, the gate includes a left-side panel adapted to swing about a vertical pivot axis and a right-side panel adapted to slide relative to the left-side panel toward and away from the vertical pivot axis to narrow and widen the gate, and the gate unit further includes an (enlarged) swing-direction controller adapted to be coupled to the right-side panel of the gate to move therewith and operable as suggested in FIGS. 10-16 to control the swing direction of the gate about the vertical pivot axis at the option of a caregiver;

FIG. 6 is an enlarged perspective view of a portion of the extensible foundation bar taken from the circled region of FIG. 5 showing an illustrative rail lock and illustrative left-side and right-side rails adapted to mate in telescoping relation as suggested in FIGS. 7-9;

FIG. 7 is a partial perspective view of the extensible foundation bar shown in FIG. 1 with portions broken away to show the rail lock mounted inside a lock-receiving passageway formed in the left-side rail and provided with near and far motion-blocker buttons mounted on a button-carrier spring and yieldably urged away from another by the button-carrier spring to extend into companion button-receiver apertures formed in the right-side rail to lock the slidable right-side rail in a fixed position relative to the stationary left-side rail;

FIG. 8 is a view similar to FIG. 7 showing application of opposing button-moving forces F₁ and F₂ to the motion-blocker buttons to cause those buttons to move toward one another to exit the companion button-receiver apertures and free the right-side rail to slide relative to the left-side rail to, for example, the position shown in FIG. 9;

FIG. 9 is a view similar to FIGS. 7 and 8 after arrival of the sliding right-side rail at a fully extended position shown in FIG. 2 and spring-driven movement of the two motion-blocker buttons away from one another to extend into companion button-receiver apertures formed in the left-side and right-side rails and associated with the widened extensible foundation bar shown in FIG. 2;

FIG. 10 is an enlarged perspective of the gate unit of FIG. 1 showing swinging movement of the gate about the vertical pivot axis in a clockwise direction (when viewed from above) toward a closed position and showing a swing-direction controller made in accordance with the present disclosure mounted on a lower right portion of the slidable right-side panel of the gate;

FIG. 11 is an enlarged view of the swing-direction controller of FIG. 10 showing that a pivotable rear motion-blocker flange included in the swing-direction controller has been deployed (e.g., pivoted about a horizontal pivot axis to a downwardly extending position) while a front motion-blocker flange included in the swing-direction controller remains in an undeployed state aligned with the right-side rail in the extensible foundation bar;

FIG. 12 is a view similar to FIG. 11 suggesting that the downwardly extending rear motion-blocker flange engages a rear wall of the right-side rail upon arrival of the swinging gate at the closed position to block further clockwise rotation of the swinging gate about the vertical pivot axis;

FIG. 13 is an enlarged view of the portion of the gate and gate mount shown in FIG. 11 after the rear motion-blocker flange has been pivoted to its undeployed position aligned with the right-side rail in the extensible foundation bar and the gate has been swung in the clockwise direction about the vertical pivot axis past the right-side rail and showing the at the front motion-blocker flange has been pivoted to assume a deployed downwardly extending position;

FIG. 14 is a view similar to FIG. 13 showing that the downwardly extending front motion-blocker flange engages a front wall of the right-side rail in response to counterclockwise swinging movement of the gate about the vertical pivot axis upon arrival of the gate at the closed position to block further counterclockwise rotation of the swinging gate about the vertical pivot axis;

FIG. 15 is an enlarged sectional view taken along line 15-15 of FIG. 11; and

FIG. 16 is an enlarged sectional view taken along line 16-16 of FIG. 13.

### DETAILED DESCRIPTION

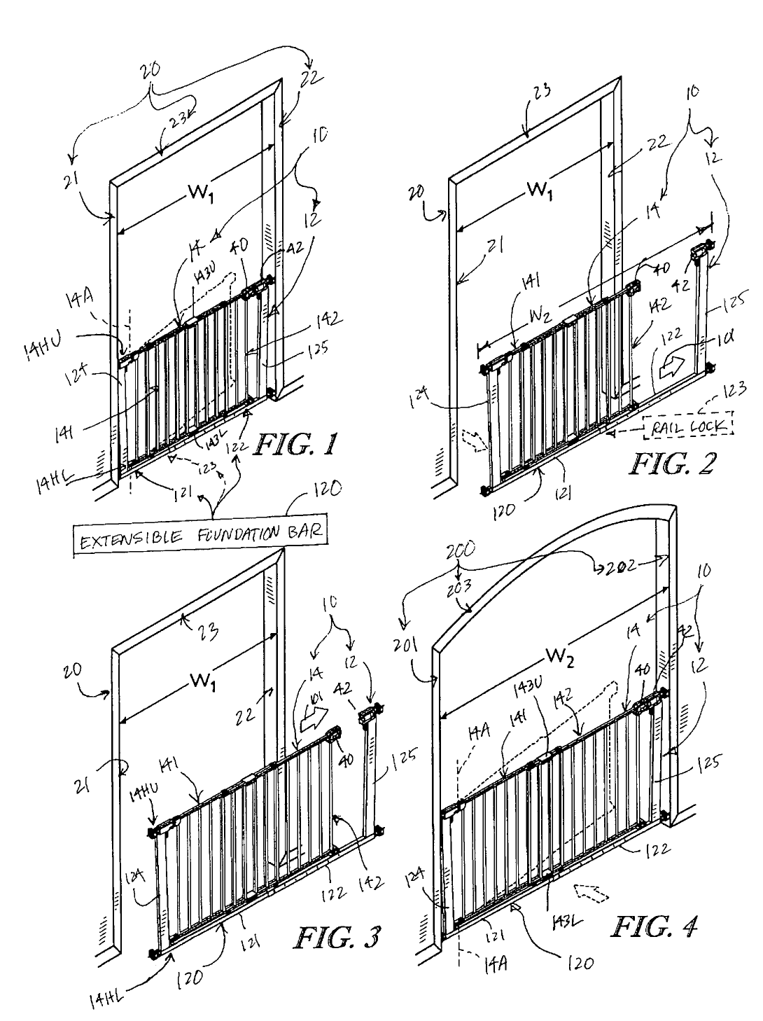

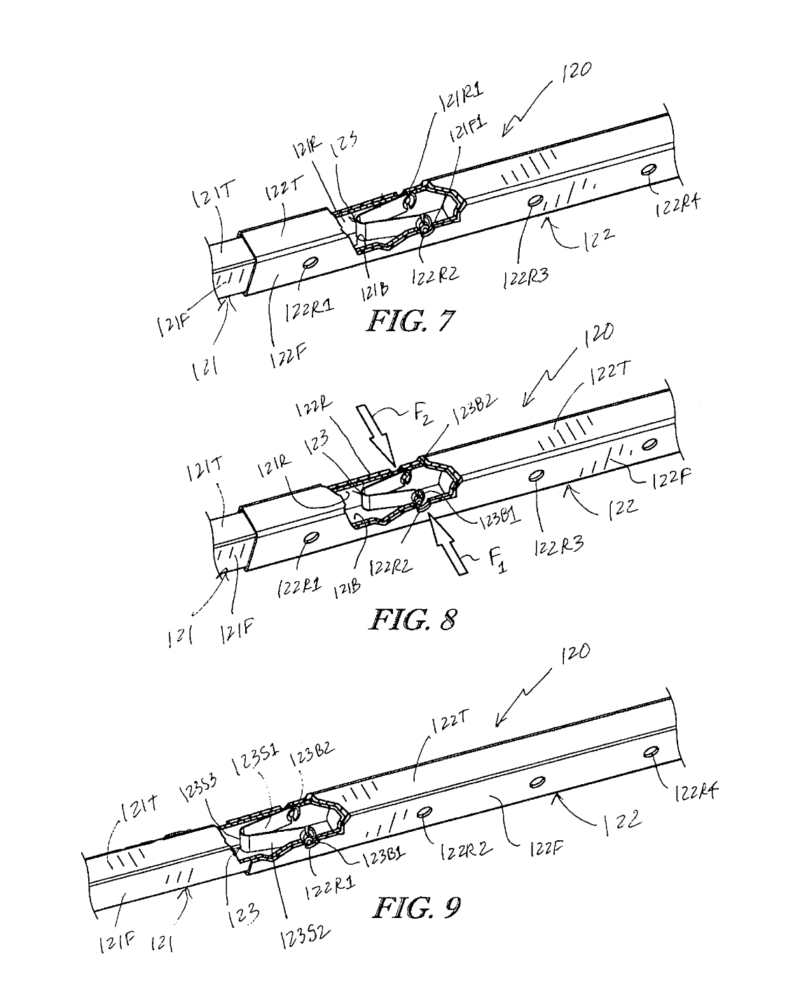

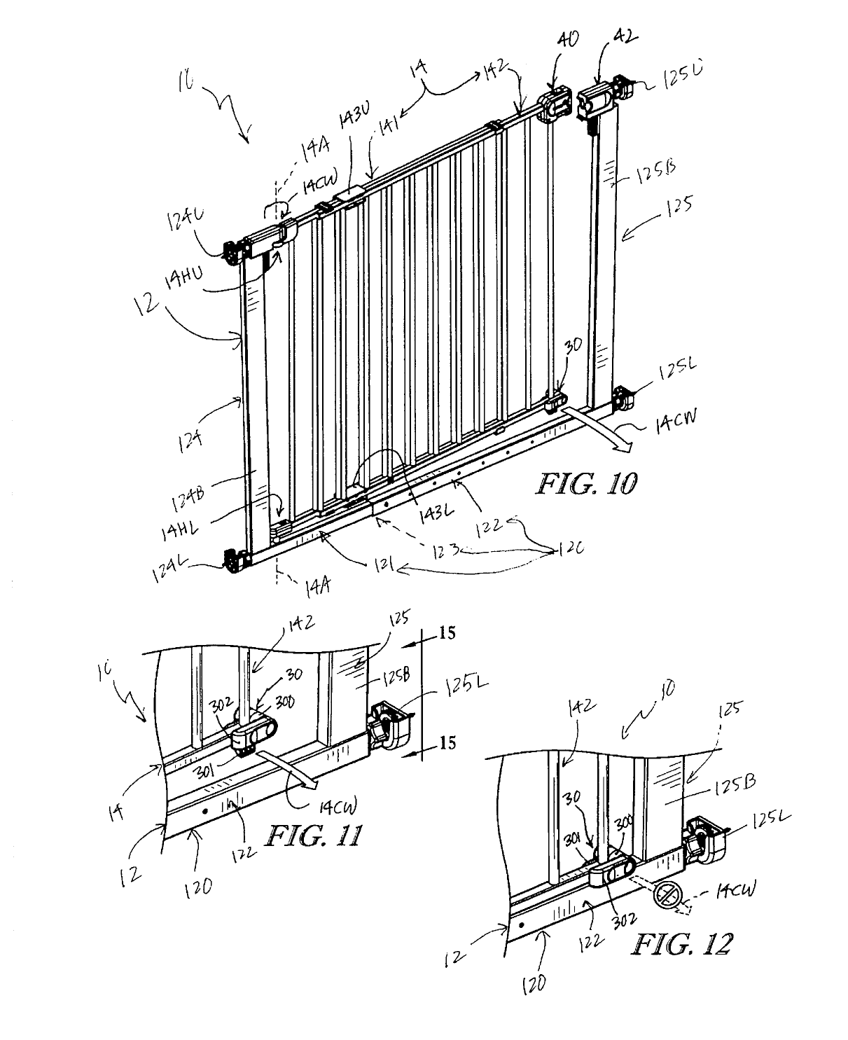

Gate unit 10 includes a gate mount 12 that is adapted to mate with a door frame 20 and a gate 14 that is mounted to swing on a vertical pivot axis 14A between opened and closed positions as suggested in FIGS. 1 and 10. Gate mount 12 is U-shaped as suggested in FIGS. 1-5 and includes an extensible foundation bar 120 that extends below and under gate 14 along the floor and can be varied in length at the option of a caregiver as suggested in FIGS. 7-9 to vary the width of gate mount 12 as suggested in FIGS. 1 and 2.

Gate 14 includes left-side and right-side panels 141, 142 that can be moved relative to one another at the option of the caregiver to narrow and widen gate 14 to match the width of the gate unit 12 as suggested in FIGS. 2-4. Upper and lower panel clamps 143U, 143L are included in gate 14 and coupled to panels 141, 142 to anchor right-side panel 142 to left-side panel 141 in a fixed position relative to left-side panel 141 to establish the width of gate 14.

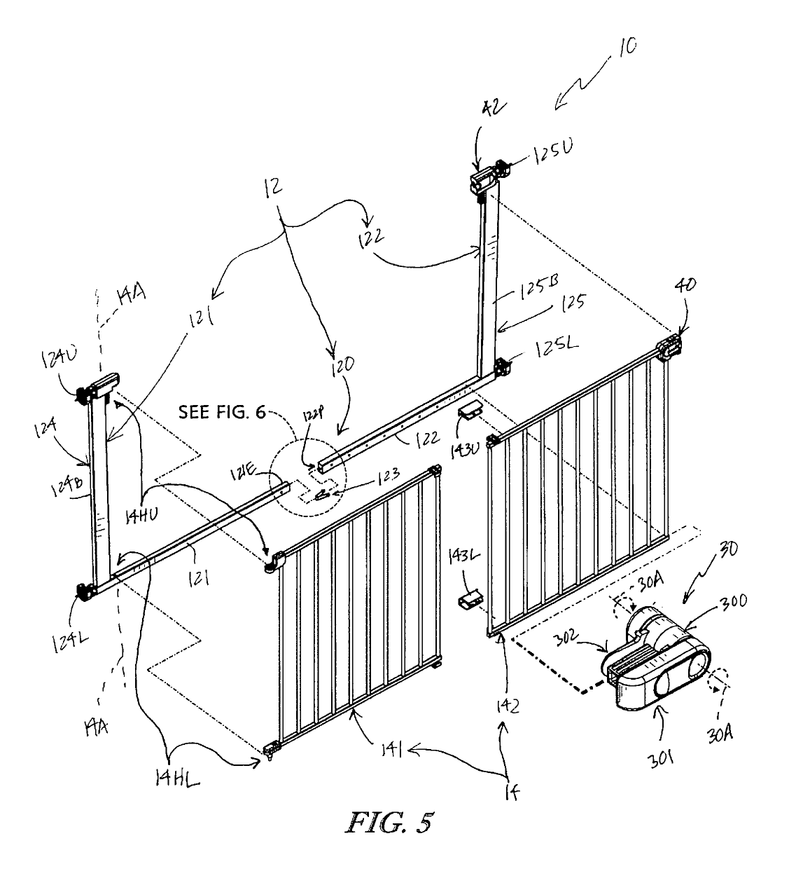

Left-side panel 141 is coupled to one side of gate mount 14 by means of upper and lower hinges 14HU, 14HL to pivot about vertical pivot axis 14A as suggested in FIGS. 1 and 5. Right-side panel 142 is configured to carry a latch 40 and to be moved relative to the pivoting left-side panel 141 to allow latch 40 to mate with a latch receiver 42 included on an opposite side of gate mount 14 upon arrival of gate 14 at a closed position. In use, gate unit 10 can be configured by a caregiver to fit in the narrow-width doorway of door frame 20 as shown in FIG. 1 or the relatively wider doorway of door frame 200 as shown in FIG. 4 and then panels 141, 142 of gate 14 can be moved relative to one another to establish a width of gate 14 that matches the selected width of gate mount 14.

Gate mount 14 includes an extensible foundation bar 120 comprising a left-side rail 121, a right-side rail 122, and a rail lock 123, an upright first side post 124, and an upright second side post 125 as shown, for example, in FIGS. 1 and 5. A lower portion of upright first side post 124 is coupled to an outer portion of left-side rail 121 while a lower portion of upright second side post 125 is coupled to an outer portion of right-side rail 122 as shown in FIG. 5. Extensible foundation bar 120 can be lengthened and shortened by a caregiver as suggested in FIGS. 1, 2, and 7-9 to vary the width of gate mount 14.

First side post 124 includes a vertical bar 124B coupled to left-side rail 121 and upper and lower doorjamb bumpers 124U, 124L coupled to vertical bar 124B. Second side post 124 includes a vertical bar 125B coupled to right-side rail 122 and upper and lower doorjamb bumpers 125U, 125L coupled to vertical bar 125B. When mounted in door frame 20 as suggested in FIG. 1, upright first side post 124 mates with first vertical doorjamb 21 of door frame 20 and upright second side post 125 mates with second vertical doorjamb 22 of door frame 20. When mounted in a relatively wider door frame 200 as suggested in FIG. 4, upright first side post 124 mates with first vertical doorjamb 201 of door frame 200 and upright second side post 125 mates with second vertical doorjamb 202 of door frame 200.

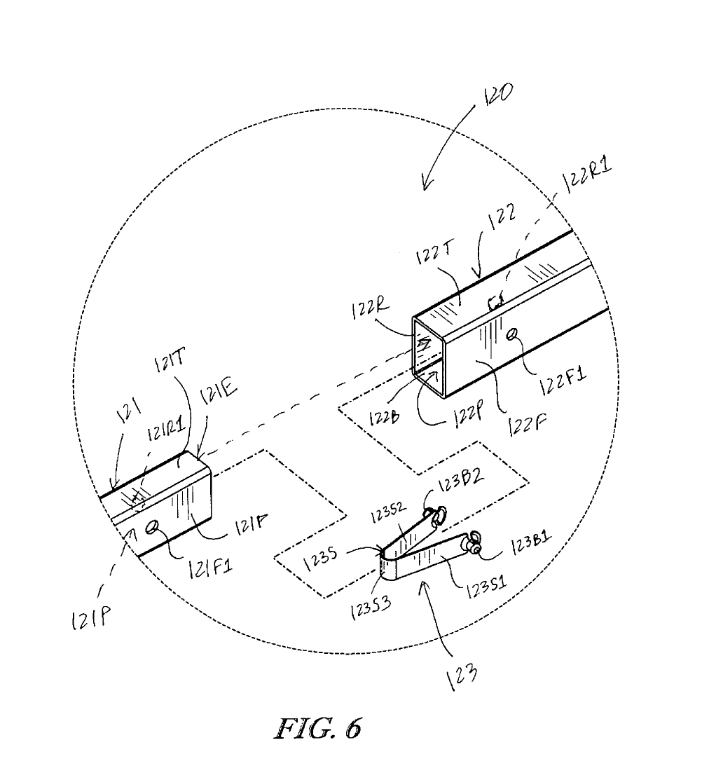

As suggested in FIGS. 6 and 7-9, a free end 121E of left-side rail 121 can be inserted into a rail-receiving passageway 122P formed in right-side rail 122 to couple rails 121, 122 in telescoping relation to one another to allow right-side rail 122 to slide back and forth relative to left-side rail 121 when rail lock 123 is disabled to shorten and lengthen extensible foundation bar 120. Each of rails 121, 122 has a rectangular cross section in illustrative embodiments as suggested in FIGS. 6-9. Left-side rail 121 includes a top wall 121T, front wall 121F, bottom wall 121B, and rear wall 121F. Front wall 121F is formed to include a front button-receiver aperture 121F1 associated with a motion-blocker button included in rail lock 123 and rear wall 121R is formed to include a rear button-receiver aperture 121R1 associated with a near motion-blocker button 123B1 included in rail lock 123. Right-side rail 122 includes a top wall 122T, front wall 122F, bottom wall 122B, and rear wall 122R. Front wall 122F is formed to include a series of laterally spaced-apart front button-receiver apertures 122F1, 122F2, 122F3 . . . associated with a near motion-blocker button 123B1 included in rail lock 123. Rear wall 122R is formed to include a series of laterally spaced-apart rear button-receiver apertures 122R1, 122R2, 122R3 . . . associated with a far motion-blocker button 123B2 included in rail lock 123.

Rail lock 123 is configured to provide means for releasably anchoring right-side rail 122 to left-side rail 121 to establish a fixed position of right-side rail 122 on left-side rail 121 to determine the length of extensible foundation bar 120 as suggested in FIGS. 6-9. In illustrative embodiments, rail lock 123 includes near and far motion-blocker buttons 123B1, 123B2 mounted on a V-shaped button-carrier spring 123S as suggested in FIG. 6. Button-carrier spring 123S is made of an elastic material and includes a first strip 123S1 coupled to near motion-blocker button 123B1, a second strip 123S2 coupled to far motion-blocker button 123B2, and a connector strip 123S3 arranged to interconnect proximal ends of first and second strips 123S1, 123S2.

During assembly, as suggested in FIG. 6, rail lock 123 is inserted into a lock-receiving passageway 121P formed in left-side rail 121 to cause near motion-blocker button 123B1 to extend outwardly into front button-receiver aperture 121F1 formed in front wall 121F of left-side rail 121 and to cause far motion-blocker button 123B2 to extend outwardly into rear button-receiver aperture 121R1 formed in rear wall 121 R of left-side rail 121. Button-carrier spring 123S is configured to provide means for yieldably urging motion-blocker buttons 123B1, 123B2 in opposite directions to remain in and extend through and out of their companion button-receiver apertures 121R1, 121F1 to anchor rail lock 123 in a predetermined position in lock-receiving passageway 121P as suggested in FIG. 7.

Motion-blocker buttons 123B1, 123B2 of rail lock 123 are depressed by a caregiver applying opposing squeezing forces F₁, F₂ as suggested in FIG. 8 to free right-side rail 122 to slide relative to left-side rail 121 to shorten or lengthen extensible foundation bar 120 as suggested in FIGS. 7-9. In FIG. 7, rail lock 123 is mounted in lock-receiving passageway 121P formed in left-side rail 121. Button-carrier spring 123S yieldably urges near motion-blocker button 123B1 into and through front button-receiver aperture 121F1 formed in left-side rail 121 and into second front button-receiver aperture 122F2 formed in right-side rail 122. Button-carrier spring 123S also yieldably urges far motion-blocker button 123B2 into and through rear button-receiver aperture 121R1 formed in left-side rail 121 and into second rear button-receiver aperture 122R2 formed in right-side rail 122. Such engagement of the motion-blocker buttons in the companion button-receiver apertures locks the slidable right-side rail 121 in a fixed position relative to stationary left-side rail 122. To release such locking engagement, button-moving force F₁ is applied to near motion-blocker button 123B1 and an opposing button-moving force F₂ is applied to far motion-blocker button 123B2 as suggested in FIG. 8 to disengage the motion-blocker buttons from the companion button-receiver apertures in right-side rail 122 to free right-side rail 122 for back-and-forth sliding movement relative to stationary left-side rail 121, for example, to the new position shown in FIG. 9. At that stage, button-carrier spring 123S urges the motion-blocker buttons to move away from one another into the companion button-receiver apertures formed in right-side rail 122 shown in FIG. 9 to lock rails 121, 122 together in a new position.

The width of gate unit 10 can be increased in accordance with the present disclosure first by widening gate mount 14 and second by widening gate 12 as suggested in FIGS. 1-4. The width of gate unit 10 can be decreased by first narrowing the width of gate 12 and second narrowing the width of gate mount 14.

Gate unit 10 is mounted in door frame 20 to block movement of people and pets through a narrow-width doorway defined by door frame 28 as shown in FIG. 1. Gate unit 10 can be reconfigured at the option of a caregiver as suggested in FIGS. 2 and 3 to be mounted in a relatively wider door frame 200 as shown in FIG. 4.

After U-shaped gate unit 10 is removed from the narrow-width doorway of door frame 20 as shown in FIG. 2, a caregiver can unlock rail lock 123 as suggested in FIGS. 7-9 and move right-side rail 122 in direction 101 away from vertical pivot axis 14A and relative to left-side rail 121 to lengthen extensible foundation bar 120 and increase the width of gate mount 14. Gate mount 14 is widened from a width W₁ that matches the width of the narrow-width doorway of door frame 20 shown in FIG. 1 to a width W₂ that matches the width of a relatively wider doorway of door frame 200 shown in FIG. 4.

Next, as suggested in FIG. 3, gate 12 is widened by sliding right-side panel 142 in direction 101 away from vertical pivot axis 14A and relative to the pivotable left-side panel 141 that is mounted on a hinge coupled to the first side post 124 of the U-shaped gate mount 14 toward a second side post 125 of the U-shaped gate mount 14. Right-side panel 142 is slid to the right in direction 101 to cause latch 40 mounted on right-side panel 142 to mate with latch receiver 42 included in second side post 125. Then, as suggested, in FIG. 4, widened gate unit 10 is mounted in the relatively wider doorway of door frame 200. It is within the scope of the present disclosure to employ any suitable means for allowing caregiver-controlled movement of right-side panel 142 relative to left-side panel 141.

A gate unit 10 in accordance with the present disclosure includes a gate 14 that can be moved in a doorway about a pivot axis 14A by a person between closed and opened positions. In the closed position, gate 14 is arranged to block movement through the doorway. In illustrative embodiments, gate unit 10 also includes a gate mount 12 that is adapted to mate with a door frame bordering the doorway. Gate mount 12 is configured to support gate 14 for pivotable movement on upper and lower hinges 14HU, 14HL about pivot axis 14A between a closed position closing a walkway passage formed in gate mount 12 to block movement of a person through the walkway passage to an opened position opening the walkway position to allow movement of a person through the walkway passage. A suitable latch 40 is carried on the pivotable gate 14 and arranged to engage a suitable latch receiver 42 provided in gate mount 12 and coupled to second side post 125 to lock gate 14 in the closed position as suggested in FIGS. 1 and 4.

In illustrative embodiments, gate mount 12 is U-shaped and is configured to be varied in width at the option of a caregiver to fit both narrow and relatively wider doorways as suggested in FIGS. 1-4. The variable-width gate mount 12 includes an extensible foundation bar 120 arranged to extend along the floor in the doorway, a first side post 124 arranged to extend upwardly from a first end of extensible foundation bar 120 to mate with a first vertical doorjamb 21 included in a door frame 20, and a second side post 125 arranged to extend upwardly from a second end of extensible foundation bar 120 to lie in spaced-apart relation to first side post 124 and mate with a second vertical doorjamb 22 included in door frame 20.

In illustrative embodiments, extensible foundation bar 120 of U-shaped gate 12 mount includes a first rail 121 coupled to first side post 124, a second rail 122 coupled to second side post 125 and mounted to slide relative to first rail 121 to vary the width of the gate mount 12, and a rail lock 123. Rail lock 123 is configured to retain second rail 122 in a stationary position relative to first rail 121 at the option of a caregiver to establish and fix the width of the gate mount 12.

Gate unit 10 further includes a swing-direction controller 30 coupled to gate 14 to pivot therewith. Swing-direction controller 30 is operable to control the swing direction of gate 14 about vertical pivot axis 14A at the option of a caregiver. Swing-direction controller 30 includes a flange carrier 300 mounted in a stationary position on gate 14 and front and rear motion-blocker flanges 301, 302 mounted for pivotable movement on flange carrier 300 about a horizontal pivot axis 30A between undeployed positions aligned with extensible foundation bar 120 and downwardly extending deployed positions arranged to intercept and engage extensible foundation bar 120 to block further swinging movement of gate 14 about vertical pivot axis 14A.

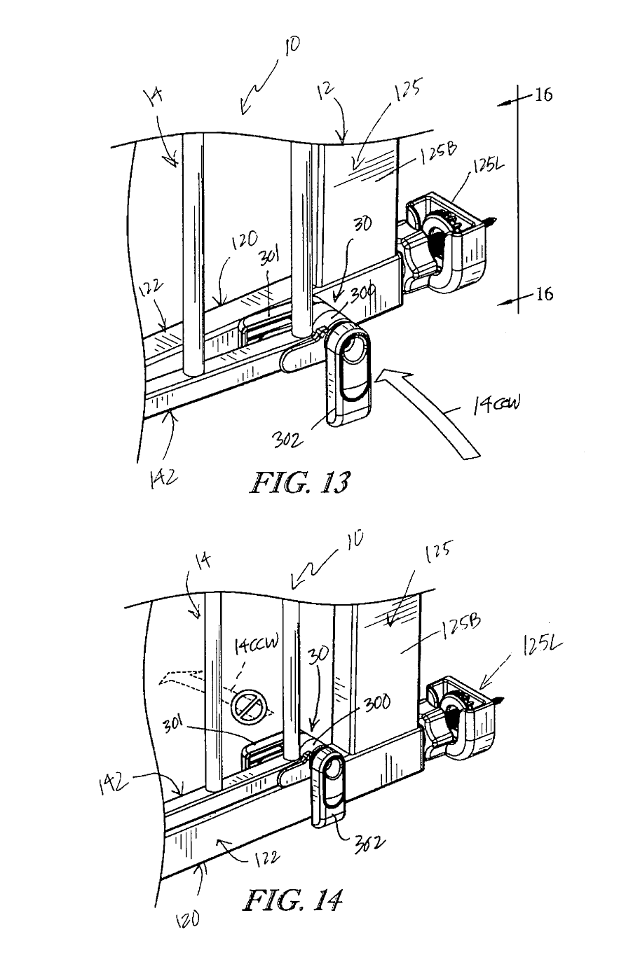

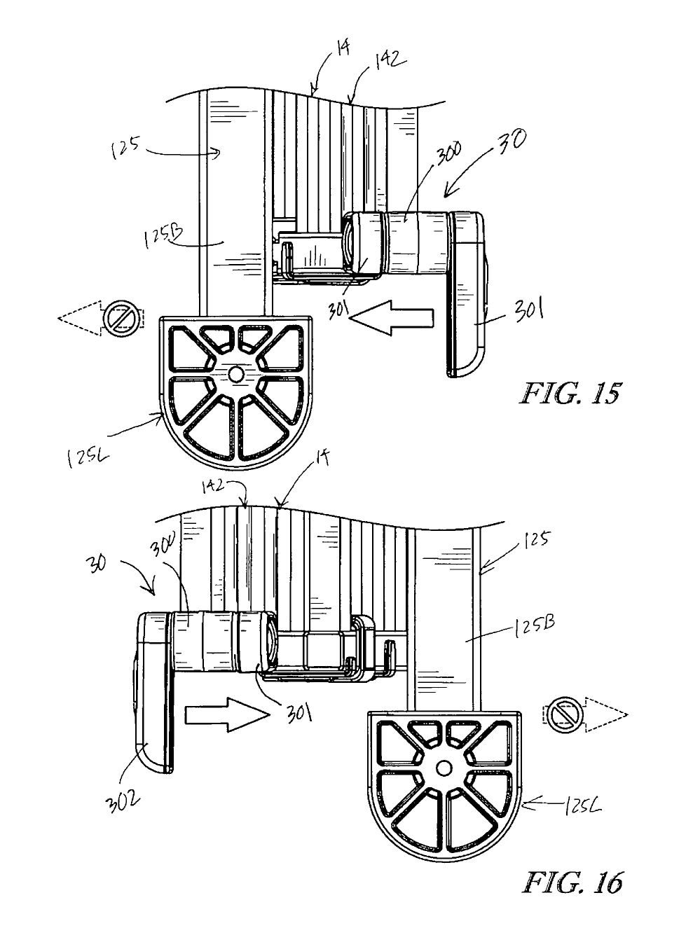

Gate 14 can be arranged to swing on hinges 14HU, 14HL in a clockwise direction 14CW to a closed position as suggested in FIGS. 10-12 and in a counterclockwise direction 14CCW to a closed position as suggested in FIGS. 13 and 14 by proper operation of swing-direction controller 30. Swing-direction controller 30 is mounted on a lower right portion of the slidable right side panel 142 of gate 14 as suggested, for example, in FIGS. 5 and 10.

Swinging movement of gate 14 on hinges 14HU, 14HL about vertical pivot axis 14A in a clockwise direction 14CW (when viewed from above) toward a closed position is shown in FIG. 10. As suggested in FIGS. 10 and 11, a pivotable rear motion-blocker flange 302 included in swing-direction controller 30 has been deployed by being pivoted about horizontal pivot axis 30A to a downwardly extending position while a pivotable front motion-blocker flange 301 included in swing-direction controller 30 remains in an undeployed state aligned with right-side rail 122 in extensible foundation bar 120. As suggested in FIG. 12, the downwardly extending rear motion-blocker flange 302 is arranged to engage a rear wall 122R of right-side rail 122 upon arrival of the swinging gate 14 at the closed position to block further clockwise rotation of the swinging gate 14 about vertical pivot axis 14A.

An enlarged view of the portion of gate 14 and gate mount 12 shown in FIG. 11 is provided in FIG. 13 after rear motion-blocker flange 301 has been pivoted to its undeployed position aligned with right-side rail 122 in extensible foundation bar 120 and gate 14 has been swung in clockwise direction 14CW about vertical pivot axis 14A past right-side rail 122. Front motion-blocker flange 302 has been pivoted to assume a deployed downwardly extending position as shown in FIG. 13. As suggested in FIG. 14, the downwardly extending front motion-blocker flange 302 engages a front wall of right-side rail 122 in response to counterclockwise swinging movement of gate 12 about vertical pivot axis 14A upon arrival of gate 12 at the closed position to block further counterclockwise rotation of the swinging gate 12 about vertical pivot axis 14A.

1. A gate unit comprising
an extensible gate adapted to be widened or narrowed to block openings of various widths, the extensible gate including a first panel and a slidable second panel supported for lateral sliding movement relative to the first panel to vary the width of the extensible gate,
a variable-width gate mount adapted to mate with a door frame bordering a doorway, the variable-width gate mount including an extensible foundation arranged to underlie the extensible gate and adapted to extend along a floor in the doorway, a first side post arranged to extend upwardly from a first end of the extensible foundation and adapted to mate with a first vertical doorjamb included in the door frame and to carry a hinge to support the extensible gate for pivotable movement about a gate-pivot axis relative to the variable-width gate mount between opened and closed positions, and a second side post arranged to extend upwardly from a second end of the extensible foundation bar to lie in spaced-apart relation to the first side post and adapted to mate with the extensible gate to retain the extensible gate in the closed position, wherein the extensible foundation includes a first rail associated with the first side post, a second rail associated with the second side post and mounted to slide relative to the first rail to vary the width of the variable-width gate mount, and a rail lock mounted on the first rail and arranged to engage the second rail to retain in a selected stationary position relative to the first rail at the option of a caregiver to establish and fix the width of the variable-width gate mount.

2. The gate unit of claim 1, wherein the first rail includes an outer end coupled to the first side post and an opposite free end coupled to the rail lock and the second rail includes an outer end coupled to the second side post and an opposite free end arranged to face toward the first side post and to be engaged by the rail lock.

3. The gate unit of claim 2, wherein the second rail is formed to include a rail-receiving passageway, the free end of the second rail is formed to include an end aperture opening into the rail-receiving passageway, and the free end of the first rail is arranged to extend through the end aperture into the rail-receiving passageway of the second rail to couple the first and second rails in telescoping relation to one another to allow the second rail to slide back and forth on the first rail when the rail lock is disengaged from the second rail to shorten and lengthen the extensible foundation bar.

4. The gate unit of claim 3, wherein the second rail is formed to include a series of button-receiver apertures arranged to extend in spaced-apart relation to one another between the free and outer ends of the second rail, the rail lock is coupled to the first rail to move therewith relative to the second rail and configured to include a motion-blocker button that is arranged to extend into one of the button-receiver apertures formed in the second rail during movement of the first rail relative to the second rail to block further relative movement of the first and second rails and establish and fix the width of the variable-width gate mount.

5. The gate unit of claim 4, wherein the first rail is formed to include a first button-receiver aperture, the first motion-blocker button is arranged to extend through the first button-receiver aperture formed in the first rail into one of the series of button-receiver apertures formed in the second rail to block further relative movement of the first and second rails in response to relative movement of the first and second rails to align the first button-receiver aperture formed in the first rail in side-by-side registry with said one of the series of button-receiver apertures formed in the second rail.

6. The gate unit of claim 1, wherein the second rail is formed to include a series of button-receiver apertures arranged to extend in spaced-apart relation to one another between the free and outer ends of the second rail, the rail lock is coupled to the first rail to move therewith relative to the second rail and configured to include a motion-blocker button that is arranged to extend into one of the button-receiver apertures formed in the second rail during movement of the first rail relative to the second rail to block further relative movement of the first and second rails and establish and fix the width of the variable-width gate mount.

7. The gate unit of claim 6, wherein the first rail is formed to include a first button-receiver aperture, the first motion-blocker button is arranged to extend through the first button-receiver aperture formed in the first rail into one of the series of button-receiver apertures formed in the second rail to block further relative movement of the first and second rails in response to relative movement of the first and second rails to align the first button-receiver aperture formed in the first rail in side-by-side registry with said one of the series of button-receiver apertures formed in the second rail.

8. The gate unit of claim 7, wherein the first rail is formed to include a lock-receiving passageway, the button-receiver aperture formed in the first rail is arranged to open into the lock-receiving passageway, the rail lock further includes a button-carrier spring located in the lock-receiving passageway formed in the first rail and coupled to the motion-blocker button, and the button-carrier spring is configured to provide means for urging the first motion-blocker button to extend through the first button-receiver aperture formed in the first rail and for yieldably urging a distal tip of the motion-blocker button to extend into said one of the series of button-receiver apertures formed in the second rail in response to relative movement of the first and second rails to align the first button-receiver aperture formed in the first rail in side-by-side registry with said one of the series of button-receiver apertures formed in the second rail.

9. The gate unit of claim 1, wherein the rail lock is configured to provide means for releasably anchoring the first rail to the second rail to establish a fixed position of the second rail on the first rail to establish a fixed length of the extensible foundation bar.

10. The gate unit of claim 9, wherein the rail lock includes a first motion-blocker button mounted on the first rail for movement therewith during relative movement of the first and second rails and for movement relative to the second rail, the rail lock further includes a button-carrier spring carried by the first rail and coupled to the first motion-blocker button to move the first motion-blocker button relative to the first and second rails, the second rail is formed to include a first set of at least two button-receiver apertures along a length thereof, and the button-carrier spring is arranged to urge the first motion-blocker button into a first of the button-receiver apertures formed in the second rail and included in the first set to provide the extensible foundation bar with a first length and into a second of the button-receiver apertures formed in the second rail and included in the first set to provide the extensible foundation bar with a relatively shorter second length.

11. The gate unit of claim 10, wherein the first rail is formed to include a button-receiver aperture and the button-carrier spring is arranged to urge the first motion-blocker button into the button-receiver aperture formed in the first rail to cause a distal tip of the first motion-blocker button to extend into and through a button-receiver aperture formed in the second rail to lie in an exposed position extending away from the second rail and lying in a region surrounding an exterior surface of the second rail upon relative movement of the first and second rails to align the button-receiver apertures of the first and second rails in side-by-side registry with one another.

12. The gate unit of claim 11, wherein the first rail is formed to include a lock-receiving passageway containing the button-carrier spring and the button-receiver aperture formed in the first rail is arranged to open into the lock-receiving passageway.

13. The gate unit of claim 10, wherein the button-carrier spring is V-shaped and includes a first strip, a second strip, and a connector strip arranged to interconnect proximal ends of the first and second strips, the first motion-blocker button is coupled to a free end of the first strip, the second rail is formed to include a second set of at least two button-receiver apertures along a length thereof, the rail lock further includes a second motion-blocker button coupled to a free end of the second strip to cause the free ends of the first and second strips to lie between the first and second motion-blocker buttons, the button-carrier spring is arranged to urge the second motion-blocker button into a first button-receiver aperture formed in the second rail and included in the second set when the first motion-blocker button is urged into the first of the button-receiver apertures formed in the second rail and included in the first set and the button-carrier spring is arranged to urge the second motion-blocker button into a second of the button-receiver apertures formed in the second rail and included in the second set when the first motion-blocker button is urged into the second of the button-receiver apertures formed in the second rail and included in the first set.

14. The gate unit of claim 13, wherein the second rail includes a bottom wall arranged to face away from the overlying extensible gate, a top wall arranged to lie in spaced-apart relation to the bottom wall to face toward the overlying extensible gate, a front wall arranged to interconnect the bottom and top walls and formed to include the first set of at least two button-receiver apertures, and a rear wall arranged to interconnect the bottom and top walls and cooperate with the front wall to define a rail-receiving passageway therebetween and formed to include the second set of at least two button-receiver apertures, and the free end of the first rail is arranged to extend into the rail-receiving passageway.

15. The gate unit of claim 14, wherein the button-carrier spring is arranged to urge a distal tip of the first motion-blocker button to extend into, through, and out of a button-receiver aperture included in the second set of at least two button-receiver apertures and formed in the front wall of the second rail to lie in an exposed position extending away from the front wall of the second rail in a region surrounding exterior surfaces of the second rail.

16. The gate unit of claim 14, wherein the first rail includes a bottom wall arranged to face away from the overlying extensible gate, a top wall arranged to lie in spaced-apart relation to the bottom wall to face toward the overlying extensible gate, a front wall arranged to interconnect the bottom and top walls and formed to include the first button-receiver aperture formed in the first rail, and a rear wall arranged to interconnect the bottom and top walls and formed to include a second button-receiver aperture arranged to receive the second motion-blocker button therein, the button-carrier spring is located in a lock-receiving passageway formed in the first rail and bounded by the bottom, top, front, and rear walls of the first rail and arranged to communicate with the first and second button-receiver apertures formed in the first rail, and the button-carrier spring is configured to provide means for urging the first motion-blocker button to extend through the first button-receiver aperture formed in the front wall of the first rail and for yieldably urging a distal tip of the first motion-blocker button into the first of the button-receiver apertures formed in the second rail and included in the first set and means for urging the second motion-blocker button to extend through the second button-receiver aperture formed in the rear wall of the first rail and for yieldably urging a distal tip of the second motion-blocker button into a second of the button-receiver apertures formed in the second rail and included in the second set.

17. A gate unit comprising
a U-shaped gate mount adapted to be varied in width at the option of a caregiver to fit both narrow and relatively wider doorways, the gate mount including an extensible foundation bar adapted to extend along a floor in the doorway, a first side post arranged to extend upwardly from a first end of the extensible foundation bar and adapted to mate with a first vertical doorjamb included in a door frame defining the doorway, and a second side post arranged to extend upwardly from an opposite second end of the extensible foundation bar, the extensible foundation bar including a first rail coupled to the first side post, a second rail coupled to the second side post and mounted to slide relative to the first rail in telescoping relation to the first rail to vary the width of the gate mount, and a rail lock coupled to the first rail to move therewith relative to the second rail and configured to include a motion-blocker button and a spring arranged to yieldably urge the motion-blocker button into a first button-receiver aperture formed in the second rail to retain the second rail in a first position relative to the first rail to establish a first width of the extensible foundation and into a second button-receiver aperture formed in the second rail to lie in spaced-apart relation to the first button-receiver aperture to retain the second rail in a second position relative to the first rail to establish a relatively wider second width of the extensible foundation, and
an extensible gate mounted on the first side post for pivotable movement about a pivot axis between a closed position arranged to engage the second side post and an opened position separated from the second side post.

18. The gate unit of claim 17, wherein the first rail is formed to include a lock-receiving passageway and a button-receiver aperture opening into the lock-receiving passageway and the spring is located in the lock-receiving passageway and arranged to urge the motion-blocker button through the button-receiver passageway formed in the first rail and also through the first button-receiver aperture formed in the second rail when the first button-receiver aperture is aligned to lie in side-by-side registry with the button-receiver aperture and through the second button-receiver aperture formed in the second rail when the second button-receiver aperture is aligned in side-by-side registry with the button-receiver aperture.

19. The gate unit of claim 17, wherein the second rail is formed to include a rail-receiving passageway, the first and second button-receiver apertures are formed in the second rail to open into the rail-receiving passageway, the first rail is arranged to extend into and move back and forth in the rail-receiving passageway formed in the second rail to vary the width of the extensible foundation, and the motion-blocker button is arranged to extend away from the first rail into the rail-receiving passageway and into the first button-receiver aperture formed in the second rail to establish the first width of the extensible rail and into the second button-receiver aperture formed in the second rail to establish the second width of the extensible rail.

20. A gate unit comprising
a gate mount adapted to mate with a door frame bordering a doorway, the gate mount including a foundation bar adapted to extend along the floor between first and second vertical doorjambs included in the door frame and separated to define the doorway therebetween,
a gate mounted on the gate mount for pivotable movement about a vertical pivot axis between opened and closed positions and arranged to lie above the foundation bar when the gate occupies the closed position, and
a swing-direction controller coupled to the gate to pivot therewith, wherein the swing-direction controller includes a flange carrier mounted in a stationary position on the gate, a front motion-blocker flange mounted for pivotable movement on the stationary flange carrier about a horizontal pivot axis between an undeployed position arranged to lie above the underlying foundation bar to avoid intercepting and engaging the foundation bar during swinging movement of the gate about the vertical pivot axis and a deployed position arranged to intercept and engage a front side of the foundation bar during swinging movement of the gate about the vertical pivot axis in a first swing direction to block further swinging movement of the gate about the vertical pivot axis in the first swing direction, and a rear motion-blocker flange mounted for pivotable movement on the stationary flange carrier about a horizontal pivot axis between an undeployed position arranged to lie above the underlying foundation bar to avoid intercepting and engaging the foundation bar during swinging movement of the gate about the vertical pivot axis and a deployed position arranged to intercept and engage an opposite rear side of the foundation bar during swinging movement of the gate about the vertical pivot axis in an opposite second swing direction to block further swinging movement of the gate about the vertical pivot axis in the second swing direction.
